(19) United States
(12) Patent Application Publication
(10) Pub. No.: US 2010/0035141 A1
(43) Pub. Date: Feb. 11, 2010

(54) Enhanced Electrolyte Percolation in Lithium Ion Batteries

(76) Inventor: Victor Grosvenor, Woodland Hills, CA (US)

Correspondence Address: STOUT, UXA, BUYAN & MULLINS LLP, 4 VENTURE, SUITE 300, IRVINE, CA, 92618, US

(21) Appl. No.: 12/539,359

(22) Filed: Aug. 11, 2009

Related U.S. Application Data
(60) Provisional application No. 61/087,946, filed on Aug. 11, 2008.

(51) Int. Cl. H01M 10/052; H01M 4/02; H01M 2/14; B05D 5/12; H01M 4/139

(52) U.S. Cl. 429/129; 429/209; 427/126.1

(57) ABSTRACT

New lithium ion batteries and methods useful in making lithium ion batteries and/or components thereof are provided. The present lithium ion batteries and/or components thereof are structured to allow enhanced ion diffusion into and out of an active material through an electrolyte and to provide enhanced heat transfer out of the active material. The present methods provide electrodes with enhanced porosity without employing a separate porosity additive or a separate electrolyte percolation additive.

### CROSS-REFERENCE TO RELATED APPLICATIONS

This application claims the benefit of U.S. Provisional Patent Application Ser. No. 61/087,946, filed Aug. 11, 2008, which application is incorporated in its entirety herein by reference.

### BACKGROUND OF THE INVENTION

The present invention relates to the field of lithium-ion batteries, more particularly to such batteries including one or more lithium ion cells and to methods useful in making lithium ion cells.

Advances in performance and reliability of rechargeable lithium ion batteries has enabled such batteries to be used in a variety of applications. For example, lithium ion batteries are used in an array of mobile networking and productivity enhancing electronic devices, such as cell phones, laptop computers, personal digital assistants, digital cameras, and the like, etc. The commercial success of lithium ion secondary batteries applied to electronic devices has helped to drive down the cost sufficiently that lithium ion batteries may be considered for large format applications, such as traction batteries in electric vehicles and hybrid electric vehicles as alternatives to fossil fuel power transportation vehicles.

The good performance of rechargeable lithium ion batteries compared to other galvanic systems derives, at least in part, from the relatively high standard reduction potential, 3.045 volts, for lithium. Since the reduction potential of lithium is greater than the electrolysis potential of water, a non-aqueous, for example, organic, electrolyte, or electrolytic carrier, is used to cycle a lithium secondary battery. The conductivity of organic electrolytes used for lithium ion cells are typically much lower than aqueous electrolytes. However, in general, a decrease in electrolyte conductivity in a battery cell results in decreased power performance.

Compensation for or mitigation of the lower electrolyte conductivity is central to designing lithium ion batteries. Lithium ion battery designs typically use minimal active material and separator thicknesses. To increase capacity the active material particle sizes are minimized, for example, particle sizes on the order of about 1 micron or about 2 microns or about 5 microns to about 15 microns, to increase the surface area, thereby resulting in an increased number of active sites for the lithium ion redox reactions. However, the small size of the active material particles results in low void volume between the particles. For example, in a conventional lithium ion battery, the inter-particle void porosity, that is the void space between the active material particles, is typically 15 to 25% of the volume occupied by the active material, e.g., the active material layer or active material powder bed.

In a lithium ion battery cell, the electrolyte typically includes a lithium salt dissolved in a non-aqueous carrier or solvent, for example, an aprotic organic solvent for the lithium salt. The non-aqueous solvent may be, for example, an alkyl carbonate such as dimethyl, diethyl, or propylene carbonate; and the lithium salt may be, for example, lithium hexaflurophosphate or lithium boron tetrafluoride, among others.

On discharge, lithium is oxidized at the negative electrode or anode and the cathode material is reduced at the positive electrode. On discharge, lithium ions must diffuse away from the negative electrode and into the positive electrode. The counter-anion must diffuse away from the positive electrode and into the negative electrode to prevent excessive polarization of the electrodes at high discharge rates. In either charge mode or discharge mode, the battery may develop localized heat in the positive electrode active material and the negative electrode active material.

The prior art has employed the concept of porosity and various strategies of creating porosity in the active material powder beds for the proposed purpose of either electrolyte ionic mobility or mitigation of dimensional changes in the active material particles.

For example, Sugnaux et al US Patent Application US2004/0131934A1 discloses electrically conductive solid nanoparticles added to the active material forming a three-dimensional reticulated framework or a mesoporous agglomeration. While the use of solid conductive nanoparticles, such as titanium dioxide, maintains the conductive network of the active particles, agglomerations of solid nanoparticles have limited porosity and limited control of electrolyte percolation.

Pu et al in US Patent Application US2008/0038638 discloses lithium anode active material particles encapsulated in a conductive porous matrix to form composite porosity enhanced active material particles. The porous matrix is optimized to accommodate swelling of certain anode active materials occurring upon lithium insertion during charging. The purpose is to prevent certain anode active materials prone to swelling from breaking up due to expansion resulting in reduced battery cycle life. Pu et al does not contemplate or recognize porosity enhancers for the purpose of electrolyte percolation.

Another example of employing porosity to mitigate the detrimental effects of certain types of anode active material particles is disclosed by Bito et al US Patent Application US2008/0096110A1. Bito et al proposes embedding the swelling susceptible anode particles into a porous metallic foam like current collector.

Tanjo et al in US Patent Application US202/0028380A1 proposes controlling the void porosity in the active material layer using a mixture of active material particles. Tango et al discloses that larger diameter particles increase void porosity in-between the active material particles and, thus, increase the electrolyte migration resulting in higher power. Smaller diameter particles impede electrolyte migration resulting in less power but higher capacity due to the higher surface area of the smaller particles. Tanjo et al discloses that the power density can be increased by increasing the void porosity of the active material layer by admixtures of active material particles or varying diameters. The gravimetric energy density of the battery remains constant using this strategy.

There continues to be a need for lithium ion batteries which can be cost effectively manufactured and used and/or which have useful and even enhanced performance characteristics.

### SUMMARY OF THE INVENTION

New lithium ion batteries and methods useful in making lithium ion batteries and/or components thereof have been discovered. The present lithium ion batteries and/or components thereof are structured to allow enhanced ion diffusion into and out of an active material of a lithium ion cell and/or to provide enhanced heat transfer out of the such active material.

By way of definition, the combined ability of the electrolyte present in a lithium ion battery to facilitate or assist ion diffusion and heat transfer into and/or out of an active material of a lithium ion battery is referred to herein as the percolation ability of the electrolyte or the percolation of the electrolyte.

In one broad aspect of the present invention, new lithium ion batteries are provided. In general, the present lithium ion batteries comprise a lithium ion cell including one or more electrodes containing an active material, a porous electrolyte percolation additive in an amount effective to increase the void porosity of the active material and a non-aqueous electrolyte in contact with the active material. The lithium ion cell is structured to have, and advantageously does have, an increased ability to allow ion diffusion into and out of the active material through the electrolyte and an increased ability to transfer heat out of the active material relative to an identical lithium ion cell without the porous electrolyte percolation additive.

It has been found that a number of benefits are achieved in lithium ion battery performance in accordance with the present invention. Included among these benefits are the following.

Employing an effective amount of a porous electrolyte percolation additive (PEPA), for example and without limitation discrete particles and/or fibers of PEPA, with the active material in an electrode of a lithium ion battery in accordance with the present invention, with the mass of active material remaining constant, provides better or enhanced or increased diffusion of lithium ions and the associated counter anions into and out of the active material. This results in higher battery discharge rates or higher power or higher gravitational power density, for example, relative to an identical battery without the porous electrolyte percolation additive. This combination of porous electrolyte percolation additive and active material may be useful for large format stationary batteries, for example and without limitation, such batteries used by utilities for managing transient power spikes, and the like applications.

By employing an effective amount of a porous electrolyte percolation additive with the active material in accordance with the present invention, the mass of active material can be increased to a greater extent, relative to an identical battery without the porous electrolyte percolation additive, without a detrimental loss of power, to provide a battery with higher gravimetric energy density, relative to a battery, for example, an identical battery, without the porous electrolyte percolation additive. This combination of porous electrolyte percolation additive and active material, for example, increased amounts of active material may be useful for large format batteries for electric vehicles, for example, by extending the range, that is by increasing the number of miles or distance able to be traveled, between battery charges, of an electric vehicle, and the like applications. Increasing the gravimetric energy density by increasing the mass of active material may reduce manufacturing processing to archive higher battery performance and, thus, make lithium ion batteries less expensive to manufacture. Being able to increase the amount of active material and the gravimetric energy density to a greater extent in accordance with the present invention without suffering the detriments noted above provides further performance and cost advantages.

Enhanced or increased electrolyte percolation in accordance with the present invention facilitates heat transfer, for example, by convection, from or out of the active material, for example, and into the separator assembly of the battery. Thus, enhanced electrolyte percolation, for example, relative to an identical battery without the porous electrolyte percolation additive, may provide enhanced, for example and without limitation, more effective, thermal management of the lithium ion battery. Such enhanced thermal management may be beneficial for a lithium ion battery for power tools and the like, for example, requiring less cool down time before charging; as well as for large format lithium ion batteries used in electric or hybrid electric vehicles and the like applications, requiring less auxiliary power to operate heat exchangers for cooling the battery.

In another broad aspect of the present invention, methods for making a lithium ion battery electrode, for example, for a lithium ion battery, are provided. These methods generally comprise forming a mixture of lithium salt crystals, particles of an active material, a binder component and a solvent for the binder component. The lithium salt crystals are very sparingly soluble or substantially insoluble in the solvent in the mixture. The mixture, for example, slurry, is applied to a current collector. The solvent is removed from the mixture and an article is formed in which the active material, the binder component and the lithium salt crystals are present in a layer bound to the current collector.

In one embodiment, the present methods further comprise contacting the article with a non-aqueous solvent for the lithium salt crystals at conditions effective to dissolve the lithium salt crystals and provide porosity in the layer bound to the current collector. The non-aqueous solvent and the dissolved lithium salt crystals may be at least a portion of an electrolyte useful in a lithium ion battery.

The present methods provide electrodes with enhanced porosity without employing a separate porosity additive or a separate electrolyte percolation additive. Moreover, the materials used to manufacture the electrode, for example, the lithium salt crystals, can also be used, for example, in the electrolyte, in the final battery. Thus, the present methods are straightforward and provide highly functional electrodes and lithium ion batteries at reduced manufacturing costs.

Various embodiments of the present invention are described in detail in the detailed description and additional disclosure below. Any feature or combination of features described herein are included within the scope of the present invention provided that the features included in any such combination are not mutually inconsistent as will be apparent from the context, this specification, and the knowledge of one of ordinary skill in the art. In addition, any feature or combination of features may be specifically excluded from any embodiment of the present invention.

These and other aspects and advantages of the present invention are apparent in the following detailed description and claims, particularly when considered in conjunction with the accompanying drawings in which like parts bear like reference numerals.

### BRIEF DESCRIPTION OF THE DRAWINGS

FIG. 1 is a simplified schematic view of a lithium ion battery in accordance with the present invention.

FIG. 2 is a schematic view of one embodiment of a half-cell of a lithium ion battery in accordance with the present invention.

FIG. 3 is a schematic view of another embodiment of a half-cell of a lithium ion battery in accordance with the present invention.

FIG. 4 is a schematic view of a further embodiment of a half-cell of a lithium ion battery in accordance with the present invention.

FIG. 5 is a schematic view of an additional embodiment of a half-cell of a lithium ion battery in accordance with the present invention.

FIG. 6 is a schematic view of an alternate half-cell of a lithium ion battery produced in accordance with a method of the present invention.

FIG. 7 is a schematic view of a portion of a half-cell of a lithium ion battery in accordance with the present invention showing the presence of a binder.

### DETAILED DESCRIPTION OF THE INVENTION

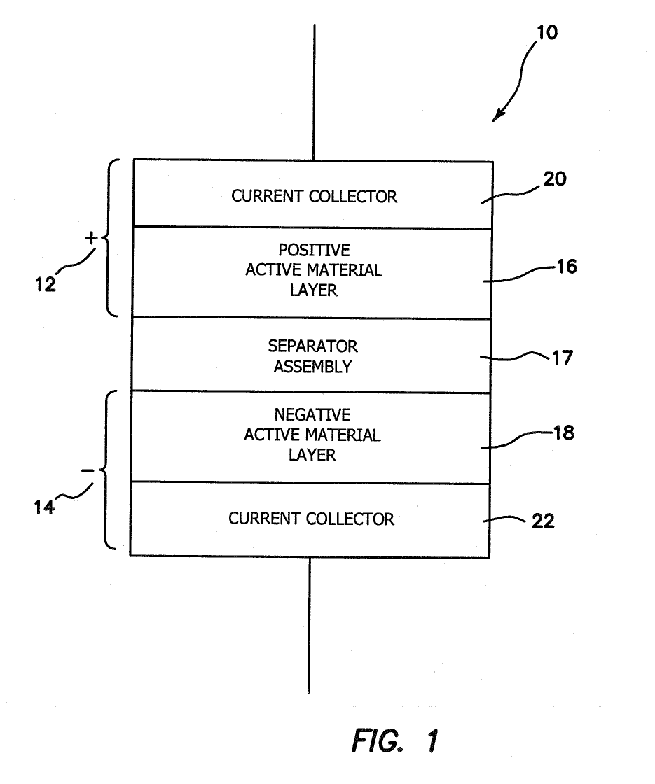

Referring to FIG. 1, a lithium ion battery 10 is shown. Although only one battery cell, made up of two half-cells coupled together, is shown—for illustrative purposes—battery 10 may include 2, 3, 4 or more such cells, for example, in series or parallel.

By convention, the positive electrode 12 is referred to as the cathode, and the negative electrode 14 is referred to as the anode. A separator assembly 17 is positioned between the two electrodes 12 and 14. By definition, on discharge the anode 14 is undergoing oxidation and the cathode 12 is being reduced.

The positive active material is present in positive active material layer 16, and the negative active material is present in negative active material layer 18.

The first and second current collectors 20 and 22, as well as the separator assembly 17 may be of conventional structure and construction and may be made of conventional and well known materials suitable for the purpose intended.

The first or positive current collector 20 is typically made of aluminum; while the second or negative current collector 22 is typically made of copper.

The battery separator assembly, such as separator assembly 17, functions, for example, to separate the positive active material from the negative active material. The separator assembly may include, for example and without limitation, micro-porous polymeric fabrics made from polyolefins, such as polyethylene or polypropylene; solid polymer electrolytes such as lithium salts dissolved into polyethylene oxide or polypropylene oxide films; and solid electrolyte gels containing the electrolyte gelled with one or more of polyethylene oxide, polyacrylonitrile, polymethylmethacrylate, and polyvinylidine difluoride and the like.

The structures and compositions of the positive and negative active material layers 16 and 22, respectively, will be discussed hereinafter.

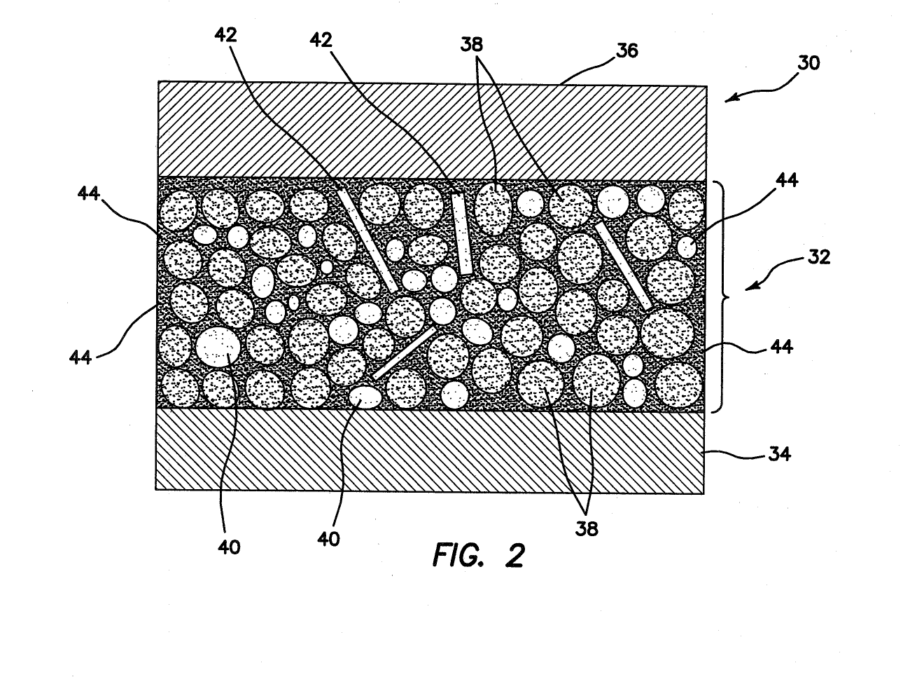

Referring now to FIG. 2, a half-cell 30 of a lithium ion battery, such as battery 10, is shown. This half-cell 30 may include either a cathode or an anode. In other words, the description set forth herein with regard to the physical structure of the present half-cells applies substantially equally to cathode-containing half-cells and the anode-containing half-cells. Of course, the compositions of the cathode or positive active material and cathode current collector and the anode or negative active material and anode current collector are different due to the different functioning of each of these two electrodes in the lithium ion battery.

With specific regard to FIG. 2, half-cell 30 includes an active material layer 32, located between a current collector 34 and a separator assembly 36.

Active material layer 32 includes active material particles 38, porous electrolyte percolation additive, hereinafter referred to as PEPA, particles 40, PEPA elongated fibers 42, and as a conductivity enhancer, small carbon particles 44.

Although not shown in FIG. 2, active material layer 32 (as well as all the other active material layers shown in the drawings) includes a binder effective to bind the active material together and to the current collector of the half-cell or electrode, for example, to current collector 34.

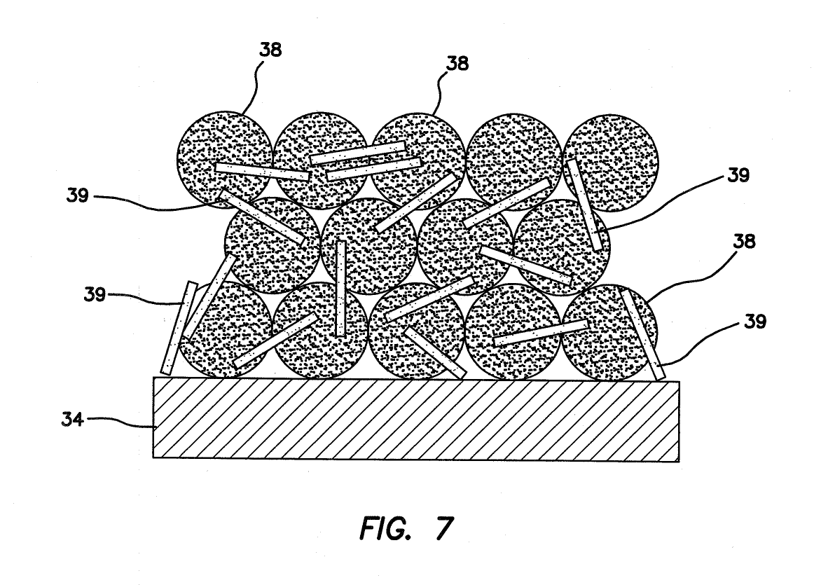

Such binder is shown in some detail in FIG. 7 In particular, with reference to FIG. 7, active material particles 38 (as well as PEPA particles 40—not shown in FIG. 7) are mixed with an organic solvent typically n-methyl pyrolidone and, softened binder fibers, for example and without limitation, selected from polyvinylidene difluoride (PVDF) fibers and the like. Such fibers may be softened by contact with the organic solvent used, for example, n-methyl pyrolidone. The resulting mixture is applied to the current collector 34. The solvent is removed by heating and after a time, the binder fibers harden and become secured to two or more active materials particles 38, PEPA particles and the current collector 34, thereby securing or binding the active material particles 38 (and the PEPA particles) together and to the current collector 34. As noted above, such a binder may be advantageously used in all the electrodes disclosed or shown herein.

Again, with reference to FIG. 2, the PEPA particles 40 and fibers 42 are effective to increase the void porosity within the active material layer 32. The use of different sized and/or different shaped PEPA particles 40 and fibers 42 creates paths or passageways to assist the movement of the non-aqueous electrolyte (not specifically shown in FIG. 2) through the layer 32. This provides for more contacting between the active material particles 38, the PEPA particles 40 and fibers 42 and the electrolyte in layer 32. Without wishing to limit the invention to any particular theory of operation, it is believed that such structure facilitates increased ion diffusion and heat transfer through the active material layer 32.

The non-aqueous electrolyte is present throughout each of the active material layers shown in the drawings. The electrolyte is not specifically shown in the drawings in order to more clearly illustrate other components within such active material layers. However, it is understood that the non-aqueous electrolyte is present.

In any event, active layer 30 provides increased ion diffusion through the electrolyte and increased transfer of heat out of the active layer relative to an identical active layer without the PEPA particles 40 and fibers 42.

In addition to the increased void porosity created by the PEPA particles 40 and fibers 42, a further substantial increase in the porosity of the active material layer 32 is provided by the fact that the PEPA particles 40 and fibers 42 are themselves porous.

In one embodiment, the porous electrolyte percolation additive, such as PEPA particles 40, include a plurality of interconnected open pores structured to allow the electrolyte to flow or pass from one interconnected pore to another interconnected pore through the porous electrolyte percolation additive. The PEPA fibers 42 may also have a similar interconnected pore structure. In one embodiment, the PEPA is in the form of hollow particles and/or fibers. The hollow space or spaces defined by such particles and/or fibers may be considered to be an interconnected pore(s) since such space or spaces are in communication, e.g., fluid communication, with one or more open pores which extend from the outer surface of the particle or fiber to the hollow, interior, space or spaces of the particle or fiber. In addition, the PEPA particles and fibers may define open ended hollow spaces. For example, elongated PEPA fibers, such as fibers 42, may be in the form of a hollow porous tubular structure in which the hollow space is open at both ends. Thus, the electrolyte can pass through the hollow space, from one open end to the other open end, and in addition, can pass from the hollow space through other pores in the PEPA fibers to the outer surface of the fibers.

One or more of these various structures of the porous electrolyte percolation additives useful in the present batteries provide substantial additional porosity, that is porosity in addition to the void porosity obtained from the presence of the porous electrolyte percolation additive, for example, the PEPA particles 40 and fibers 42. This void porosity and additional internal porosity feature of the present porous electrolyte percolation additive, together with the porosity of the active material, provides for the total porosity within the active material layer or layers of the present batteries, for example, active material layer 32, to be increased relative to an identical active material layer without the porous electrolyte percolation additive. Such total porosity of the present active material layer or layers may be increased relative to an identical active material layer including a solid (non-porous) porosity additive in place of the PEPA.

In one embodiment, the total porosity of the active material layer or layers of the electrode or electrodes of the present batteries, for example, an active material layer including the active material and the porous electrolyte percolation additive is at least about 40% or at least about 50% or at least about 60% or at least about 70% or more of the total volume of the active material layer.

Particles of the porous electrolyte percolation additive, such as PEPA particles 40, may be of any suitable size effective to function in accordance with the present invention. In one embodiment, the PEPA particles may have a maximum transverse dimension of at least about 1 micron. In one embodiment, the porous electrolyte percolation additive particles have a maximum transverse dimension in a range of about 2 microns to about 50 microns. As used herein the term “transverse dimension” refers to a straight line dimension extending from one point on the particle to another point on the particle, for example, the length, width, diameter, depth and the like of the particle. Reducing the maximum transverse dimension of the porous electrolyte percolation additive particles below one micron is disadvantageous in that such small particles, for example, nanoparticles, disadvantageously reduce the amount or volume of void spaces or void porosity within the active material layer, for example, the active material layer 32. The use of such small particles is particularly disadvantageous when the particles are solid, rather than porous.

The porous electrolyte percolation additive may be present as porous particles having substantially rounded shapes. For example and without limitation, the PEPA may be present as substantially spherical particles, substantially ovoid particles, substantially cylindrical particles, substantially irregularly rounded particles and the like and mixtures thereof.

The PEPA fibers, for example, the PEPA fibers 42, may have a length of at least about 25 microns. In one embodiment, the PEPA fibers may have a length in a range of about 25 microns to about 200 microns.

The interconnecting pores of the porous electrolyte percolation additive particles 40 and fibers 42 may include pores of suitable size to be effective in accordance with the present invention. For example, such pores may have a diameter of at least about 0.01 micron or at least about 0.03 micron. In one useful embodiment, the pores have a diameter in a range of about 0.03 microns to about 1.0 microns or about 1.5 microns.

In one useful embodiment, the porous electrolyte percolation additive particles 40 and fibers 42 have a relatively low density which advantageously provides increased total porosity and other benefits, as described herein, without substantially increasing the weight of the battery. In one embodiment, the porous electrolyte percolation additive, such as PEPA particles 40 and fibers 42, has a density in a range of about 0.1 g/cc to about 0.5 g/cc, although lower density and higher density PEPAs may be employed.

The lithium ion cell in accordance with the present invention, for example, including the active material layer 32 as shown in FIG. 2, has at least one of, and advantageously both of, an increased ability to allow ion diffusion into and out of the active material through the electrolyte and an increased ability to transfer heat out of the active material relative to an identical lithium ion cell without the porous electrolyte percolation additive, for example, without the PEPA particles 40 and fibers 42.

In one embodiment, the battery in accordance with the present invention, for example, including the active material layer 32, has an increased ability to allow ion diffusion through the electrolyte into and out of the active material, for example, active material particles 38, and/or an increased ability to transfer heat through the electrolyte and out of the active material, for example, active material particles 38, relative to an identical lithium ion cell without the porous electrolyte percolation additive, for example, the PEPA particles 40 and fibers 42.

For example, the ability of the lithium ion cell in accordance with the present invention, to allow ion diffusion as described herein may be increased by at least about 10% or at least about 20% greater or at least about 25% or at least about 30% or more relative to an identical lithium ion cell without the porous electrolyte percolation additive, such as PEPA particles 40 and fibers 42.

For example, the ability of the lithium ion cell in accordance with the present invention, to allow heat transfer as described herein may be increased by at least about 10% or at least about 20% greater or at least about 25% or at least about 30% or more relative to an identical lithium ion cell without the porous electrolyte percolation additive, such as PEPA particles 40 and fibers 42.

These advantages and benefits are achieved in accordance with the present invention whether the lithium ion cell includes a positive electrode containing a cathode active material with a porous electrolyte percolation additive or a negative electrode containing an anode active material with a porous electrolyte percolation additive.

The present lithium ion batteries comprise lithium ion cells which have an increased ability to allow ion diffusion into and out of the active material through the electrolyte. Such increased ion diffusion provides the lithium ion cell, and ultimately the lithium ion battery, with increased gavimetric power density, for example, relative to an identical lithium ion cell with the same amount of active material and without a porous electrolyte percolation additive. The increase in the gavimetrical power density of a lithium ion cell in accordance with the present invention, relative to an identical cell as noted above, can in general be correlated to the increase in the ion diffusion of the lithium ion cell of the present invention. For example, up to a 10% increase in the gravimetric power density of the present cell, relative to the above-noted identical cell, correlates to the present cell having up to a 10% greater, or increased, ability to allow ion diffusion into and out of the active material through the electrolyte, relative to the identical cell. The correlation between increasing gravimetric power density and increased ability to allow ion diffusion into and out of the active material through the electrolyte may not be a one to one correlation or even a linear correlation.

Thus, by measuring the power density of two lithium ion cells, one can determine which cell has an increased ability, and how much of an increased ability, to all such ion diffusion.

The present lithium ion batteries comprise lithium ion cells with an increased ability to transfer heat out of the active material relative to an identical lithium ion cell without the porous electrolyte percolation additive.

In one embodiment, such increased ability to transfer heat allows the present lithium ion cells to function longer and/or cooler under a given set of conditions relative to the above-noted identical lithium ion cell.

The ability to transfer heat out of the active material can be directly correlated to the time a lithium ion cell can effectively operate under a given high load, for example, powering an operating power tool, without reaching an excessively high operating temperature. For example, if a lithium ion cell in accordance with the present invention can operate for 60 minutes under a given high load, for example, as noted above, before reaching an excessively high discharge temperature, while an identical lithium ion cell without the porous electrolyte percolation additive can operate for only 50 minutes under the same load before reaching the same excessively high discharge temperature, the present lithium ion cell has a 20% (60 minutes versus 50 minutes) increased ability to transfer heat out of the active material relative to the identical lithium ion cell. If the temperature gets too high on discharge, the charging circuits may not allow a charge because of the risk of a dangerous thermal runaway condition on charge.

Thus, by measuring lithium ion cells under the same load conditions to determine how long they can operate before reaching the same excessively high operating temperatures, one can determine which cell has an increased ability, and how much of an increased ability, to transfer heat out of the active material.

In one useful embodiment, the lithium ion cell in accordance with the present invention, for example, including the active material layer 32, may include an increased amount of active material, such as active material particles 38, with substantially no reduction in the rate of active material utilization on discharge and substantially no increase in internal electrical resistance of the active material relative to an identical lithium ion cell without the porous electrolyte percolation additive, such as PEPA particles 40 and fibers 42.

Such increased amount of active material with substantially no reduction in the rate of active material utilization on discharge and substantially no increase in internal electrical resistance of the active material, as noted above provides the battery with increased gravimetric energy density. Such increased energy density is advantageous to provide for effective and even superior functioning of the battery.

In one embodiment, the lithium ion cell in accordance with the present invention has an increased gravimetric power density relative to an identical battery without the porous electrolyte percolation additive, for example, PEPA particles 40 and fibers 42.

The porous electrolyte percolation additive may be present as PEPA particles and/or fibers of substantially the same size or of different sizes.

The porous electrolyte percolation additive, such as PEPA particles 40 and elongated fibers 42 may be electrically conductive or substantially non-electrically conductive. In order to facilitate electrical conductivity through the active material, e.g., active material layer 32, a conductivity enhancer may be included in with the active material, for example, in the active material layer 32. As shown in FIG. 2, a conductivity enhancer in the form of small particles, for example, on the order of about 0.1 micron, of carbon 44 are distributed throughout the void space of active material layer 32.

Examples of useful conductivity enhancers include, but are not limited to, carbon graphite, other forms of carbon, silicon carbides, silicon carbides, metals, metal alloys, doped metal oxide, glass coated with doped metal oxide, ceramic coated with doped metal oxide, carbon fibers, carbon whiskers, carbon nanotubes and mixtures thereof.

The porous electrolyte percolation additive, for example, PEPA particles 40 and fibers 42, may be present in an amount in a range of about 2% to about 40% or more by volume of the combination of the active material and the porous electrolyte percolation additive.

If the electrode is a negative electrode, an anode active material is employed in the active material layer, such as active material layer 32. Such active material may be chosen from any suitable anode active material effective to function in accordance with the present invention. Included among the anode active materials are, for example and without limitation, lithium metal, graphite, other forms of carbon, silicon, oxides of tin, oxides of titanium, and the like and mixtures thereof.

If the electrode is a positive electrode, the active material in the active material layer is a cathode active material. Such cathode active material may be chosen from any suitable cathode active material effective to function in accordance with the present invention. Included among the useful cathode active materials are, for example and without limitation, oxides of cobalt, oxides of nickel, oxides of manganese, oxides of vanadium, phosphates of iron, and the like and mixtures thereof.

The porous electrolyte percolation additive for example, the PEPA particles 40 and fibers 42, may be chosen from any suitable material effective to function in accordance with the present invention. Such material may be substantially impervious to the conditions which exist within the lithium ion battery. Useful PEPA materials include, for example and without limitation, glass, ceramic, polymeric materials and the like and mixtures thereof. Included among the useful polymeric PEPA materials are, for example and without limitation, polypropylene, polyvinylidine difluoride, polytetrafluoroethylene, polyamides, polyacrylonitriles and the like and mixtures thereof. Of course, the PEPA material has a suitable degree of porosity in accordance with the present invention.

Examples of commercially available materials which may be useful as porous electrolyte percolation additives, for example, in cathode materials include:

| | | | Pore | |
|---|---|---|---|---|
| | | Particle | Size | |
| | Porosity | Diameter | Range | Density |
| Manufacturer | Type | (μm) | (μm) | (g/cc) |
| 3M | Hollow Glass | 20-100 | 0.1-2 | 0.2-0.3 |
| | Microshperes | | | |
| Accurel | Polypropylene | 177-420 | 1-10 | 0.4 |
| | Powder | | | |
| Hangzhou H- | Polypropylene | 400-450 | 0.02-2 | 0.4 |
| Filtration | Hollow Fiber | OD | | (polypropylene |
| | Membrane | 40-45 ID | | membrane) |
| Axis | Calcined | | 0.1-1 | 0.16-0.2 |
| | Natural | | | |
| | Diatomaceous | | | |
| | Earth | | | |

For more uniform distribution of the porous electrolyte percolation additive into the active material layers or beds, the diameter of the PEPA may be less than 25 microns since the active material layers beds may have a range from about 3 to about 12 mils. The PEPA may need some sample preparation before use. The hollow glass microspheres can be sieved to the desired diameter. The polypropylene powders can be reduced in size with a chopping mill and then sieved to the desired diameter.

A hollow fiber additive has a fiber wall that is composed of porous polypropylene. As manufactured, diameter of these products are much too large to be used in the active material powder beds. Sample preparation may also involve size reduction with a chopping mill followed by sieving to the desired dimensions. A porous particle of the desired diameter and a high length to diameter aspect ratio may be advantageous.

The porous electrolyte percolation additive may be substantially uniformly distributed in the active material layer.

The electrolyte employed in the present lithium ion battery is a non-aqueous electrolyte which is in contact with the active material. For clarity purposes, the electrolyte is not specifically shown in the drawings. However, it is understood that the electrolyte is present throughout the active material layer or layers of the battery, for example, the active material layer 32, as shown in FIG. 2. The non-aqueous electrolyte may include one or more lithium salts dissolved in an organic carrier.

Any suitable lithium salt effective to function in accordance with the present invention may be used. Included among the lithium salts are, for example and without limitation, LiPF₆, LiBF₄, LiClO₄, LiAsF₆, LiSO₃CF₃, LiNi(SO₂C₂F₅)₂ and the like and mixtures thereof.

The organic carrier useful in the electrolyte may be chosen from any suitable material effective to function in accordance with the present invention. Included among the organic carriers are, for example and without limitation, ethylene carbonate, propylene carbonate, dimethyl carbonate, ethyl methyl carbonate diethyl carbonate, actetonitrile, tetrahydrofuran, gammabutyrolacteone and mixtures thereof.

The lithium ion battery 10, shown in FIG. 1, which includes one or more lithium ion cells as shown in FIG. 2 and described herein, is very effective when used in a number of applications. The battery 10 may be charged and recharged a number of times in order to provide long term service, for example and without limitation, in many of the applications described elsewhere herein. Of course, the application for which the battery is to be used will determine the size, power, capacity and other characteristics of the battery to be employed. Determining the specific characteristics of the battery to be employed based on the application to be served is well within the skill of the art after understanding the battery in accordance with the present invention.

In FIG. 2, the porous electrolyte percolation additive is present as a mixture of PEPA particles having substantially rounded shapes and elongated PEPA fibers.

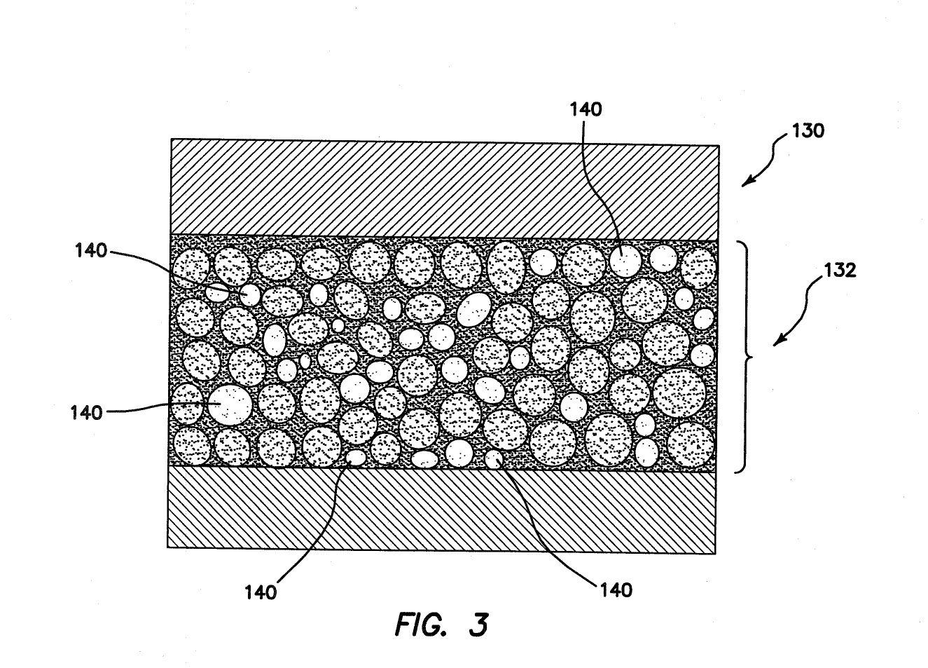

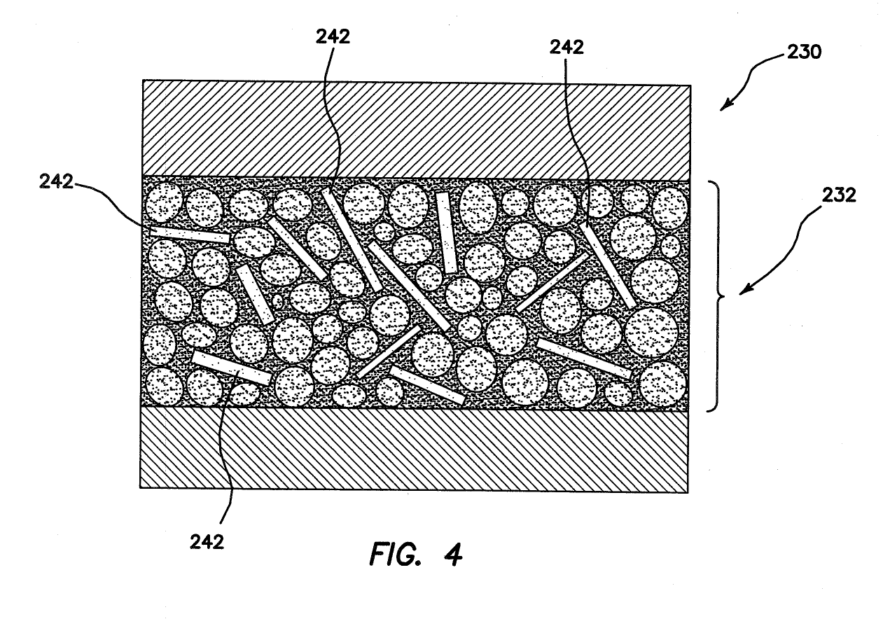

FIGS. 3 and 4 show another embodiment (FIG. 3) and a further embodiment (FIG. 4) of a half-cell of a lithium ion battery in accordance with the present invention. Except as expressly set forth herein, both of the half-cells in FIGS. 3 and 4 are structured and function substantially similarly to the half-cell shown in FIG. 2. In FIG. 3, components substantially similar to components in FIG. 2 are identified by the same reference increased by 100. In FIG. 4, components substantially similar to components in FIG. 2 are identified by the same reference numerals increased by 200.

The primary difference between the half-cell 130 of FIG. 3 and the half-cell 30 of FIG. 2 is that the active layer 132 does not include any PEPA fibers, such as PEPA fibers 42 in FIG. 2. Thus, the only porous electrolyte percolation additive included in active material layer 132 are PEPA particles 140 which, like the PEPA particles 40 of FIG. 2, have rounded surfaces. The remainder of the structure of the half-cell 130 is substantially the same as that of half-cell 30 shown in FIG. 2.

In FIG. 4, the half-cell 230 is substantially similarly structured to the half-cell 30 in FIG. 2 except that the half-cell 230 includes no PEPA particles, such as PEPA particles 40 in half-cell 30. Thus, the only porous electrolyte percolation additive included in the active layer 232 are elongated PEPA fibers 242. Since no additional porous electrolyte percolation additive is included, the number or amount of the PEPA fibers 232 is increased relative to the number of such fibers in half-cell 30 shown in FIG. 2.

It should be noted that in FIG. 3, since PEPA fibers are not included, an additional amount of PEPA particles 140 have been included relative to the amount of PEPA particles 40 in the half-cell 30 in FIG. 2.

FIGS. 3 and 4 make clear that the porous electrolyte percolation additive may be included in the active layer as entities having the same general shape or different general shapes or a combination of mutually different shapes. Also, note that the size of the PEPA particles and PEPA fibers are different, that is the PEPA particles have a size range among the particles and the PEPA fibers have a size range among the fibers.

What is important is that the PEPA particles/fibers are porous and provide the desired degree of void porosity and total porosity, and provide the battery with an increased ability to allow ion diffusion into and out of the active material through the electrolyte and/or an increased ability to transfer heat out of the active material relative to an identical lithium ion cell without the porous electrolyte percolation additive.

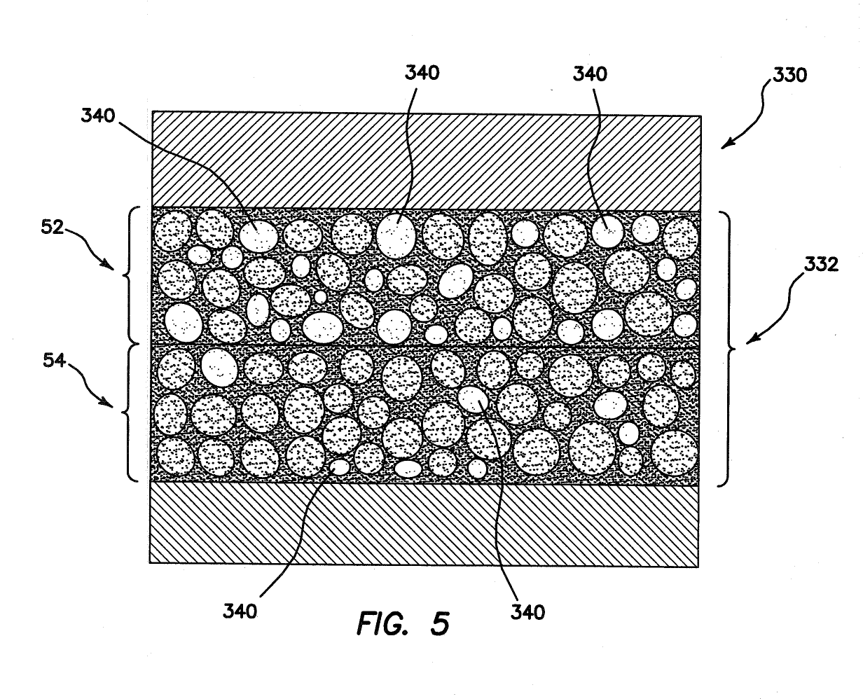

FIG. 5 shows an additional embodiment of a half-cell of a lithium ion battery in accordance with the present invention. Except as expressly stated herein, the half-cell shown in FIG. 5 is structured and functions similarly to the half-cell shown in FIG. 2. Therefore, components which are similar to components shown in FIG. 2 are indicated by the same reference numeral increased by 300.

The differences between the half-cell 330 shown in FIG. 5 and the half-cell 30 shown in FIG. 2 are as follows. In FIG. 5, the active material layer 332 includes two distinct sub-layers 52 and 54. In addition, like the half-cell shown in FIG. 3, the active layer 332 in FIG. 5 includes no elongated PEPA fibers. Thus, the only porous electrolyte percolation additive included in active layer 332 are the PEPA particles 340.

The two sub-layers 52 and 54 of active material layer 332 have a different distribution or concentration of PEPA particles 340, one from the other. In particular, the layer 52 includes a higher concentration of PEPA particles 340 then does sub-layer 54. However, sub-layer 54 includes a larger concentration of the active material particles relative to sub-layer 52.

Thus, FIG. 5 demonstrates that the porous electrolyte percolation additive, as well as the active material can be distributed non-uniformly in the active material layer. Such non-uniform distribution of the porous electrolyte percolation additive allows the placement of increased amounts of the porous electrolyte percolation additive where such increased amounts may be of increased, or even the most, benefit. For example, it may be beneficial to have more of the porous electrolyte percolation additive in a first portion, or sub-layer, of the active material layer adjacent to the separator assembly than in a second portion or sub-layer of the active material layer adjacent to the current collector to facilitate ion migration diffusion or from the first sub-layer to the second sub-layer on discharge. One advantage of a layered (non-uniform) distribution of PEPA particles shown in FIG. 5 is that, overall, less PEPA is required to achieve the same performance relative to a half cell with substantially uniform distribution of PEPA throughout the active material layer, for example, such as the half cell shown in FIG. 3 that has more PUPA than the half-cell shown in FIG. 5.

In another aspect of the present invention, the overall porosity of a lithium ion battery electrode can be increased without the addition of a separate percolation additive or a separate porosity additive. In accordance with this aspect of the present invention, methods for making a lithium ion battery electrode are provided. The methods comprise forming a mixture of lithium salt crystals, particles of an active material, for example, particles of a cathode active material or particles of an anode active material, a binder component and a solvent for softening the binder component. The binder component may be in the form of elongated fibers or filaments, for example and without limitation, polymeric fibers or filaments. The lithium salt crystals employed are to be very sparingly soluble or substantially insoluble in the solvent. The lithium salt crystals may be crystals of one or more of the lithium salts noted elsewhere herein, for example, as being useful in the electrolyte employed in the present lithium ion batteries.

The mixture, e.g., slurry, is applied to a current collector, for example, of convention composition and structure. At least a portion, for example, a major portion (at least about 50%) or substantially all of the solvent is removed from the mixture on the current collector to form an article in which the particles of active material, the binder component and the lithium salt crystals are bound to the current collector.

The method may further comprise contacting the article with a non-aqueous solvent for the lithium salt crystals at conditions effective to dissolve the lithium salt crystals and provide porosity in the active material bound to the current collector. In effect, dissolving the lithium-salt crystals results in an electrode structure in which the spaces previously occupied by the lithium ion crystals become void spaces, which remain permanently in the electrode structure and provide increased void porosity and increase total porosity to the active material layer which is bound together and to the current collector by the binding component. Such increase porosity is obtained with no separate porosity component, and provides a lithium ion battery electrode having substantial advantages. The non-aqueous solvent and the dissolved lithium salt crystals may be at least a part of an electrode useful in a lithium-ion battery.

The method of the present invention is illustrated by the following example.

The active material particles and lithium salt crystals (preferably crystalline needles) are slurried with polyvinylidene difluoride (PVDF) fibers in n-methyl-2-pyrrolidone (NMP). The slurry is applied as a layer to the current collector. The NMP softens the PVDF fibers enough so that they stick to the active material particles. The coated electrode is then heated to evaporate the NMP leaving the PVDF fibers bound to the active material. As the lithium salt crystals are only very sparingly soluble in the NMP, such crystals remain solid. After drying and removal of the NMP, the lithium salt remains embedded in the active material layer. When the non-aqueous organic solvent is added upon cell assembly, the lithium salt is assisted to dissolve into the non-aqueous solvent to form the electrolyte system. In the process, voids or channels are left in the active material where the lithium salt used to be. Since a good binder system makes the active material particles immovable, the voids or channels remain permanent.

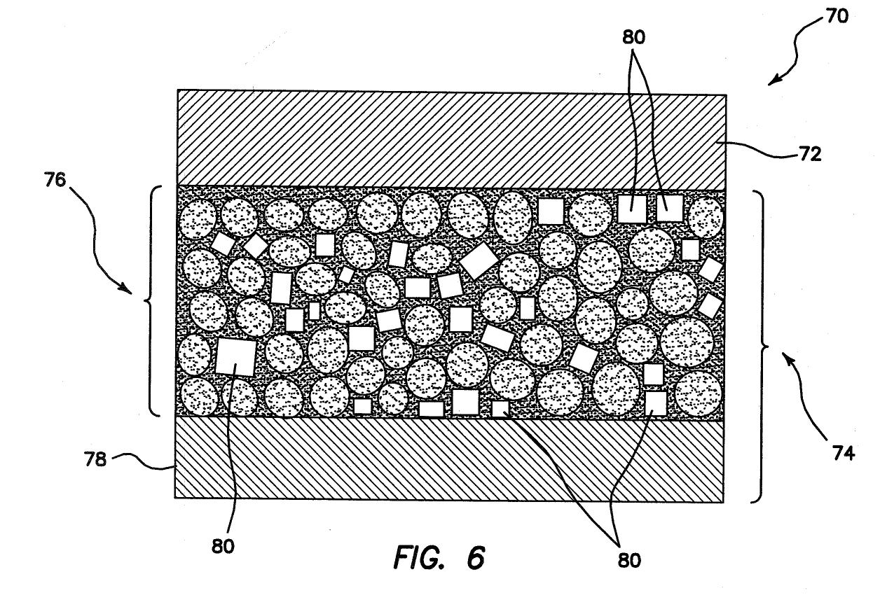

FIG. 6 shows an embodiment of a half-cell obtained in accordance with such method of the present invention.

In FIG. 6, the half-cell 70 includes a battery separator 72 and an electrode 74, including an active material layer 76 bounded to a current collector 78. The binder component is not shown in FIG. 6. However, the binder component in the half-cell 70 of FIG. 6 is substantially the same or similar to the binder 39 shown in FIG. 7. The amount of composition of the binder component should be sufficient so that, after the crystals of lithium salt are dissolved, the structure of the active material layer 76 remains substantially stable, for example, does not collapse, in spite of the presence of voids 80, and remains bound to current collector 76.

After the crystals of lithium salt have been dissolved in the non-aqueous solvent, as noted above, individual or discrete void spaces 80 occur, where the lithium salt crystals had been before dissolving, in the active material layer 70. These void spaces 80 increase the void porosity within the active material layer 76 without requiring any additional porosity additives or any additional percolation additives. Moreover, as noted above, these void spaces are produced by dissolving lithium salt crystals in a non-aqueous solvent such that both the non-aqueous solvent and the dissolved lithium crystals can be used in a lithium ion battery. Thus, the present methods provide substantial cost savings while providing a lithium ion battery electrode, and ultimately a lithium ion battery, having substantial functional benefits.

The dimensions of the crystals of lithium salt may be of substantially cubic dimensions resulting in substantially cubic voids in the active material. The length of a side of the substantially cubic lithium salt crystals may range from 10 microns to 100 microns. The crystals of lithium salt may also be in the form of needles resulting in void channels in the active material. The needles of lithium salt may have lengths in a range of about 20 microns to about 100 microns.

Each of the following publications provide information within the general field of lithium ion batteries and/or one or more aspects of the present invention:
1. NASA RFP; “Advanced Lithium Ion Cell Development”, Solicitation #NNC08ZRP024, Aug. 6, 2008.
2. Ying J., Jian C., Wan C.; Preparation and Characterization of High Density Spherical LiCO2 Cathode Material for Lithium Ion Batteries; J Power Sources, 129 (2004) 264.
3. Linden D., Reddy T.; “Handbook of Batteries, 3^{rd} Ed.”, Sections 35.8, 35,20 and 35,31, McGraw Hill (2002).
4. McEwen A., Ngo H., LeCompte K., Goldman J.; Properties of Electrolytes for Lithium Ion Batteries, J Electrochemical Soc., 146 (1999) 1687.
5. Yoshida T., Kitoh K.; Safety Performance of Large and High Power Lithium Ion Batteries with Manganese Spinel and Meso Carbon Fiber, Electrochem. and Solid State Letters, 10/3 (2007) A60
6. Zafur M., Mushi D.; “Handbook of Solid State Batteries and Capacitors”, World Scientific (1995) 503.
7. Ahn S., Yongduk K., Kim K., Kim T., Lee H., Kim M.; Development of High Capacity, High Rate Lithium Ion Batteries Utilizing metal Fiber Conductive Additives, J Power Sources, 81-82 (1999) 896.
8. Yong-Sheng H., Yu-Guo G., Wilfred S., Samumali H.; Electrochemical Lithiation Synthesis of Nanoporous Materials with Superior Capacity Activity, Nature Material, 5/9 (2006) 719
9. Sikha G., Popov B., White R.; Effect of Porosity on the Capacity Fade of a Lithium-Ion Battery, J Electrochem. Soc., 151/7 (2004) A1104.
10. McAllister S., Ponraj R., Cheng I., Edwards D.; Increase in Positive Active Material Utilization in lead Acid Batteries using Diatomaceous Earth Additives, J Power Sources, 173 (2007) 882.
11. Edwards D., Zhang S.; A Three Dimensional Conductivity Model for Electrodes in Lead Acid Batteries, J Power Sources 158 (2006) 927.
12. Zhang S., Edwards D.; Three Dimensional Conductivity Model for Porous Electrodes in Lead Acid Batteries, J Power Sources 172 (2007) 957.
13. Page J., Weng-Gutierrez M.; “Transportation Energy Forecasts for the 2007 Integrated Energy Policy Report”, California Energy Commission, CEC-600-2007-009-SF, September 2007.

Each of the patents, patent applications and publications cited in the present application is hereby incorporated in its entirety herein by reference.

While this invention has been described with respect to various specific examples and embodiments, it is to be understood that the invention is not limited thereto and that it can be variously practiced within the scope of the following claims.

1. A lithium ion battery comprising:
a lithium ion cell including one or more electrodes containing an active material, a porous electrolyte percolation additive in an amount effective to increase the void porosity of the active material and a non-aqueous electrolyte in contact with the active material, the lithium ion cell having an increased ability to allow ion diffusion into and out of the active material through the electrolyte and an increased ability to transfer heat out of the active material relative to an identical lithium ion cell without the porous electrolyte percolation additive.

2. The battery of claim 1, wherein the porous electrolyte percolation additive includes a plurality of interconnected open pores structured to allow the electrolyte to flow from one interconnected pore to another interconnected pore through the porous electrolyte percolation additive.

3. The battery of claim 1, wherein the porous electrolyte percolation additive includes pores having a diameter in a range of about 0.03 microns to about 1.5 microns.

4. The battery of claim 1, wherein the porous electrolyte percolation additive is present as discrete particles.

5. The battery of claim 1, wherein the porous electrolyte percolation additive is present as particles having a maximum transverse dimension of at least about 1 micron.

6. The battery of claim 1, wherein the porous electrolyte percolation additive has a density in a range of about 0.1 g/cc to about 0.5 g/cc.

7. The battery of claim 1 wherein the active material and the porous electrolyte percolation additive are present in a layer having a total porosity of at least about 40% of the volume of the layer.

8. (canceled)

9. The battery of claim 1, wherein the lithium ion cell has an increased ability to allow ion diffusion through the electrolyte into and out of the active material and an increased ability to transfer heat through the electrolyte and out of the active material relative to an identical lithium ion cell without the porous electrolyte percolation additive.

10. The battery of claim 1, wherein the abilities of the lithium ion cell to allow ion diffusion and transfer heat are at least about 10% greater than such abilities of an identical lithium ion cell without the porous electrolyte percolation additive.

11. (canceled)

12. (canceled)

13. (canceled)

14. (canceled)

15. (canceled)

16. The battery of claim 1, wherein the lithium ion cell includes two lithium ion half cells comprising a first lithium ion half cell having a cathode active material and a second lithium ion half cell having an anode active material, the first and second lithium ion half cells being operatively coupled together.

17. The battery of claim 16 which further comprises a battery separator assembly positioned between the first and second lithium ion half cells

18. The battery of claim 16, wherein each half cell further comprises a current collector, and an organic binder binding the active material together and to the current collector.

19. The battery of claim 1, wherein the lithium ion cell has an increased amount of active material with substantially no reduction in the rate of active material utilization on discharge and substantially no increase in internal electrical resistance of the active material relative to an identical lithium ion cell without the porous electrolyte percolation additive.

20. The battery of claim 1, wherein the lithium ion cell has an increased gravimetric power density relative to an identical lithium ion cell without the porous electrolyte percolation additive.

21. (canceled)

22. (canceled)

23. (canceled)

24. The battery of claim 1, wherein the porous electrolyte percolation additive is present as porous particles having substantially rounded shapes.

25. (canceled)

26. (canceled)

27. (canceled)

28. The battery of claim 1, wherein the porous electrolyte percolation additive is present as elongated porous fibers.

29. (canceled)

30. (canceled)

31. (canceled)

32. The battery of claim 1, wherein the lithium ion cell further includes a conductivity additive in an amount effective to increase the electrical conductivity in the lithium ion cell relative to an identical lithium ion cell without the electrical conductivity additive.

33. (canceled)

34. The battery of claim 1, wherein the porous electrolyte percolation additive is present in an amount in a range of about 2% to about 40% by volume of the combination of the active material and the porous electrolyte percolation additive.

35. (canceled)

36. (canceled)

37. The battery of claim 1, wherein the porous electrolyte percolation additive includes a material selected from the group consisting glass, ceramic, polymeric materials and mixtures thereof.

38. (canceled)

39. (canceled)

40. (canceled)

41. A method for making a lithium ion battery electrode, the method comprising:
forming a mixture of lithium salt crystals, particles of an active material, a binder component and a solvent for the binder component, the lithium salt crystals being substantially insoluble in the solvent;
applying the mixture to a current collector; and
removing the solvent from the mixture and forming an article in which the active material, the binder component and the lithium salt crystals in the form of a layer are bound to the current collector.

42. (canceled)

43. (canceled)
